(19) United States
(12) Patent Application Publication
(10) Pub. No.: US 2010/0054878 A1
(43) Pub. Date: Mar. 4, 2010

(54) Device and Method for Punching Through Rubber Products

(76) Inventors: Alain Soulalioux, Saint-Beauzire (FR); Nicolas Jeannoutot, Clermont-Ferrand (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/302,270

(22) PCT Filed: May 11, 2007
(86) PCT No.: PCT/EP2007/054584

§ 371 Date: Mar. 18, 2009

(30) Foreign Application Priority Data
May 22, 2006 (FR) 06/04644

(51) Int. Cl. B26F 1/14; B26F 1/16; B26D 7/18

(52) U.S. Cl. 408/1 R; 408/204; 408/59; 408/117

(57) ABSTRACT

A rotary hole punch (T) comprising a cylindrical head (10) with circular section, the free end (11) of which can be gripped by a means able to drive said hole punch rotationally, a cylindrical tube (20) of circular section, attached to the inner end (12) of the head (10), and ending in a cutting edge (21), characterized in that the head (10) of the hole punch includes at least one duct (13) making it possible to feed a fluid under pressure inside the tube (20) at the level of the inner end (12) of the head (10).

The invention relates to a device and a method for boring products made of rubber. More particularly, the invention relates to a hole punch intended to produce through holes, in a vulcanized rubber material.

The problem arises in producing holes with relatively high length to diameter ratio, and when a bore hole is required that passes through a given thickness of rubber.

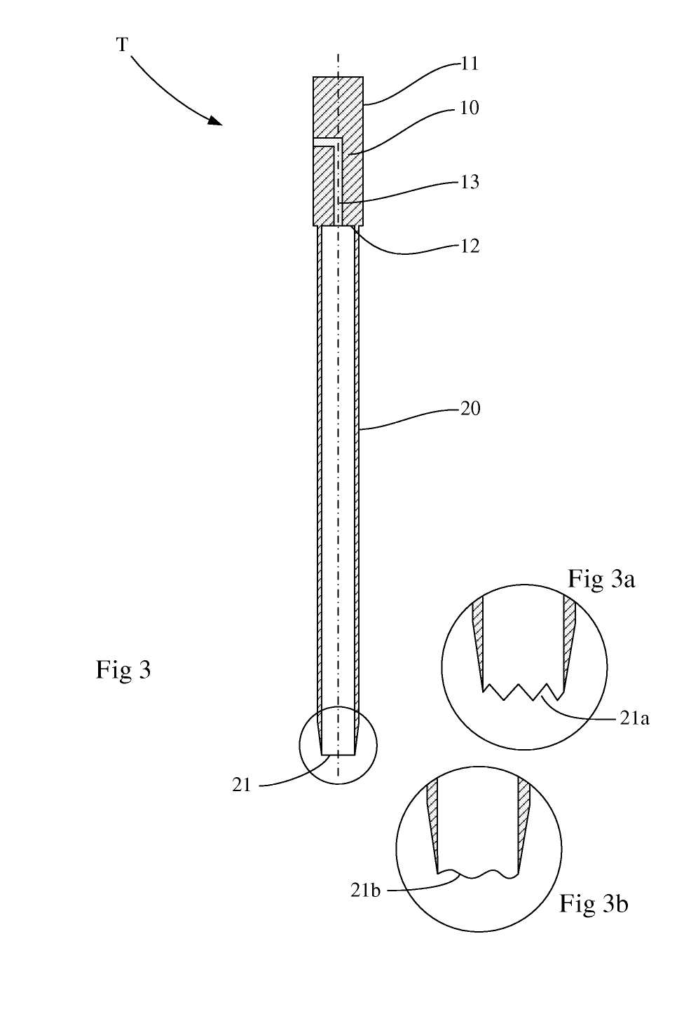

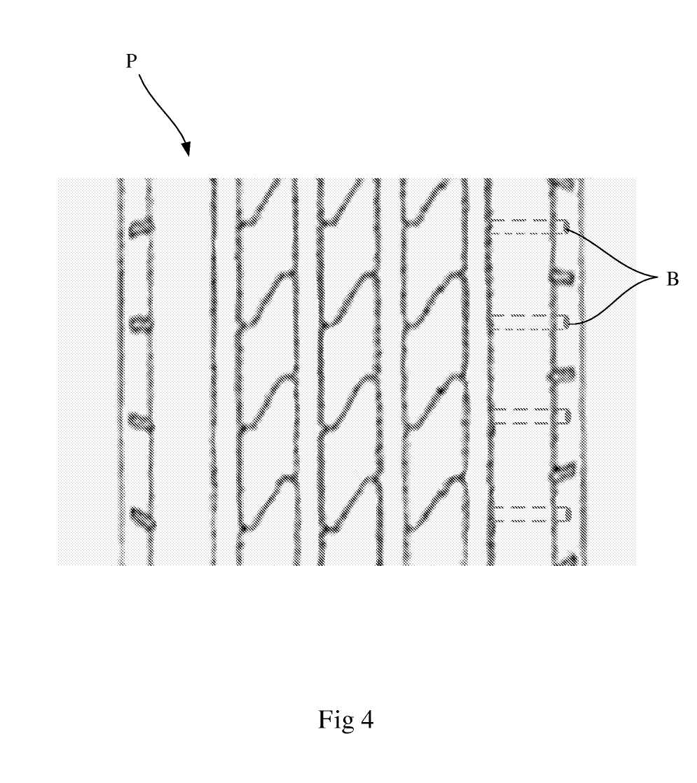

This situation occurs, for example, when there is a desire to produce a plurality of holes, in a generally axial direction, in the sculptural elements of a tire, in order to confer on said tire particular properties in the area of the tire tread, as is illustrated in FIGS. 3 and 4. These other holes make it possible among other things to improve the adhesion of the tread blocks at the end of their wear, as explained by way of example in the publication WO 2003 097384.

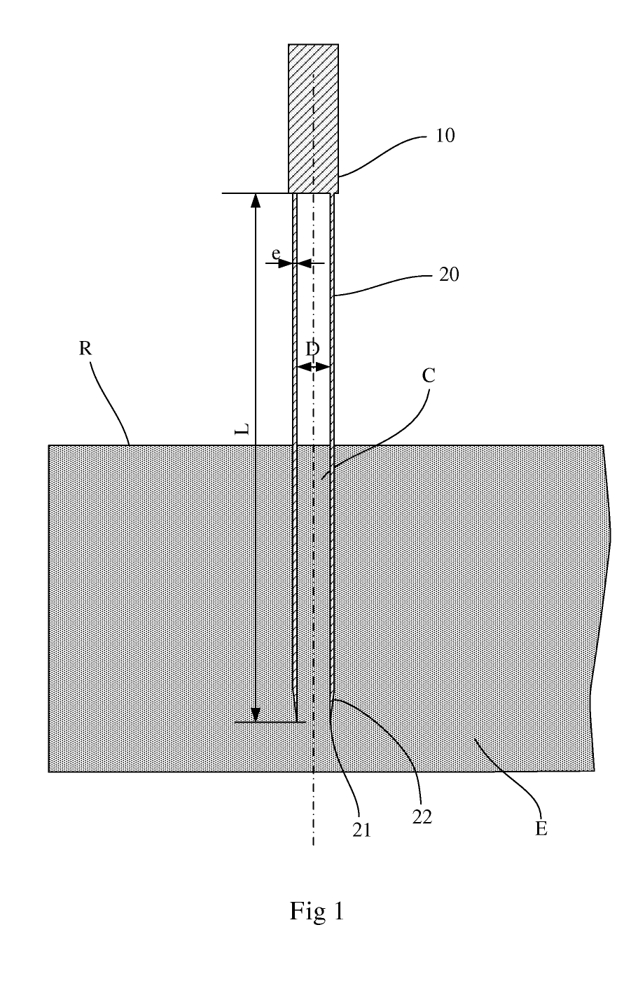

One known solution, as illustrated in FIG. 1, is to use a rotary hole punch consisting of a steel head comprising a cylindrical barrel with circular section, the top part of which is used to fix the rotary hole punch so that it can be driven rotationally, for example in the jaws of a drill.

The bottom part of the head is extended by a cylindrical hollow tube of circular section, the bottom end of which is sharpened to a cutting edge positioned in a plane perpendicular to the longitudinal axis of rotation of the tool.

A first enhancement made to this rotary hole punch consists in trimming chamfer-wise the bottom part of the head, and in forming a notch in the tube, so as to facilitate the evacuation of the material removed by the work of the tool and commonly referred to as sprue.

Another enhancement, described in the publication FR 2 483 844, consists in forming helical grooves on the outer face of the tube, the bottom of the grooves presenting through holes allowing the outer face of the tube to communicate with its inner face. This device makes it possible to circulate a lubricating fluid along the outer and inner faces of the tube in order to reduce the overheating of the tool during the boring operation.

However, the use of these types of hole punch is ill suited to producing through holes, passing through a given thickness of rubber material. In particular, when there is a desire to make small diameter holes over a long length. A hole of small diameter and long length should be understood to be a hole in which the ratio of the length to the diameter is greater than 20.

In practice, in these particular conditions of use, it can be seen that, under the effect of the elastic stresses, on the one hand, the sprue formed by the cutting jams inside the tube of the hole punch, and on the other hand, the outer wall of the hole punch is subjected to high stresses because of the material gripping it. These two phenomena lead to an abnormal overheating of the material, which can lead to the degradation of the interfaces by distillation and to the blocking of the hole punch in the boring hole, even to the breaking of the hole punch itself.

The object of the invention is to provide a solution to this problem of boring holes of small diameter and long length in a rubber material. To do this, it has been shown experimentally that it is possible to produce such boreholes, provided that the form and the dimensions of the hole punch are determined accurately and that this tool is used in well-defined conditions.

The rotary hole punch according to the invention comprises a cylindrical head of circular section, the free end of which is able to be gripped by a means intended to drive said hole punch rotationally, and a cylindrical tube of circular section, attached to the bottom end of the head, of which the ratio between the length and the diameter is between 20 and 40. This hole punch is characterized in that the tube ends in a cutting edge formed by a chamfering of the outer wall of the tube and in that said wall has a thickness e less than or equal to \sqrt{D/3} where D is the value of the inner diameter of the cylindrical tube.

The form of the chamfer forming the cutting edge makes it possible to produce a sprue, the diameter of which is at most equal to the inner diameter of the cylindrical tube. As will be seen below, this characteristic is vital if there is a desire to avoid unwanted overheating of the sprue during boring and if there is a desire to be able to extract said sprue from inside the tube when the boring is finished.

Also, an effort should be made to have a wall thickness of the tube as small as possible so that the pressure exerted by the material on the outer wall of the tube is as reduced as possible. Observation shows in fact that the thicker the wall of the tube is, the more it is necessary to compress the material to enable the hole punch to progress through the thickness of the material to be bored. This compression is the source of an intense friction which also leads to overheating of the material.

The boring method according to the invention, which implements a rotary hole punch as described hereinabove, is characterized in that the ratio between the speed of advance of the hole punch in the axial direction and the circumferential speed at the level of the cutting edge is between 0.02 and 0.2 and preferably between 0.03 and 0.15; the circumferential speed at the level of the cutting edge is easily deduced from the value of the radius and of the speed of rotation of the rotary hole punch.

It is shown in effect that this speed ratio is significant of the compression of the material by the cutting edge. The advance of the hole punch has the effect of compressing the material located under the cutting edge. By doing this, the material located above said cutting edge is extended. The effect of this is to reduce the diameter of the sprue at the moment of cutting, which makes it possible to obtain a sprue with a diameter very slightly less than the inner diameter of the cylindrical tube. The result is a reduction of the friction of the sprue on the inner surface of the cylindrical tube and greater ease in extracting said sprue when the boring is finished.

Thus, the combined effects of the design of the hole punch and of the implementation of this tool makes it possible to produce holes of long length and small diameter in industrial conditions and without degrading the material.

The description that follows is based on FIGS. 1 to 5 and illustrates a preferred embodiment of the invention in which,

FIG. 1 represents a schematic view of a hole punch according to the invention

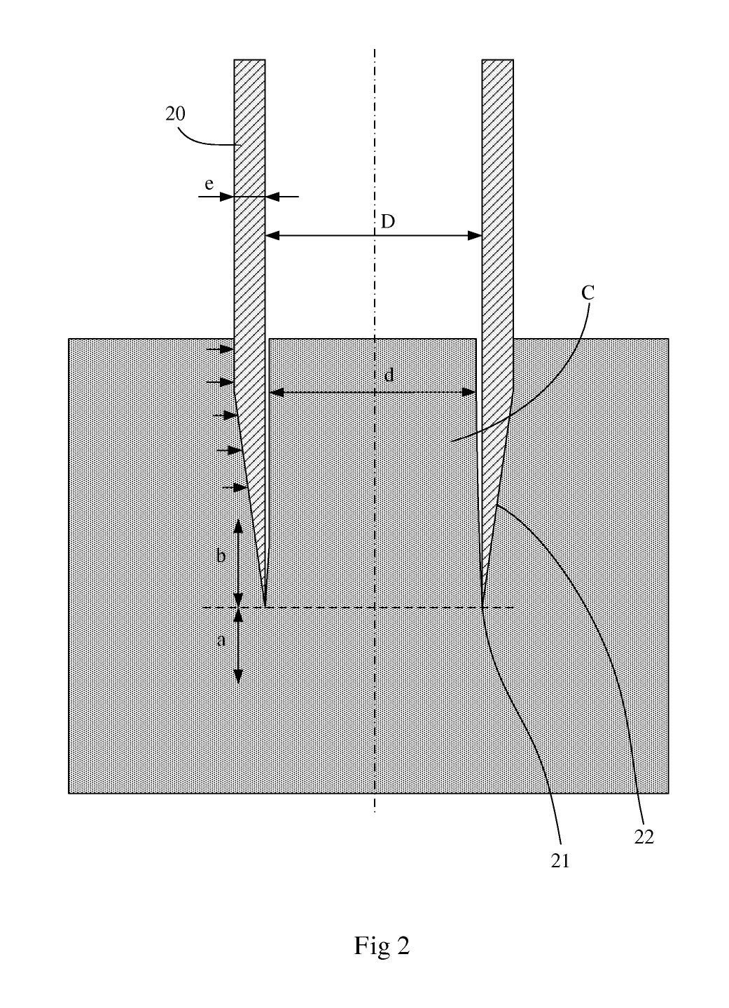

FIG. 2 represents a detail view of the cutting edge when the hole punch is implemented according to the method according to the invention

FIG. 3 represents a schematic view of a hole punch according to the invention and the insets 2a and 2b represent the different embodiments of the cutting edge,

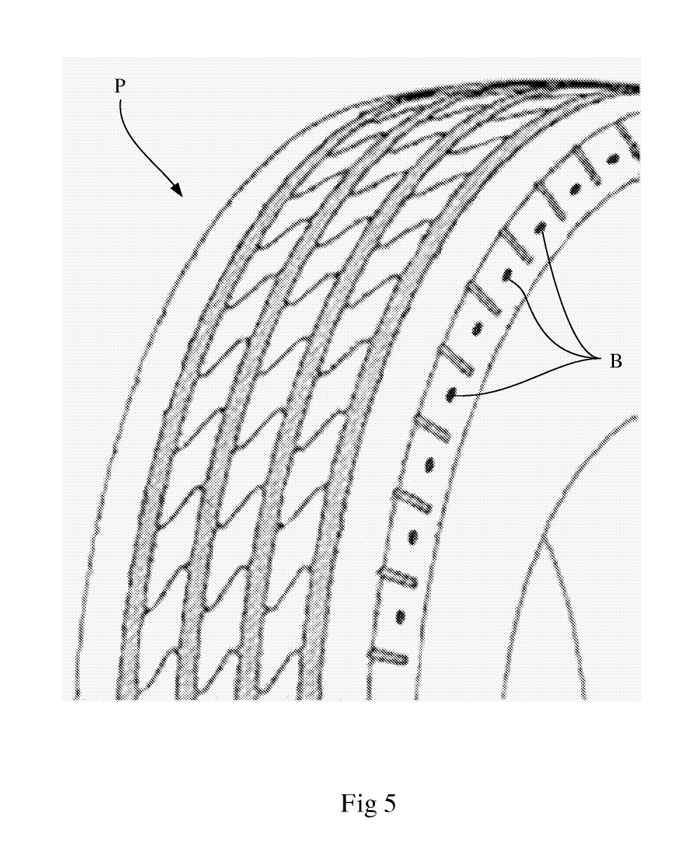

FIGS. 4 and 5 represent schematic views of a tire comprising substantially axial perforations, opening into the sculptural elements located in the shoulder zone.

With reference to the above, FIG. 1 represents a cross-sectional view of a hole punch according to the invention in which can be distinguished a head 10 attached to a hollow tube 20, the free end of which comprises a cutting edge 21. The ratio between the length (L) of the tube and the inner diameter (D) of said tube is between 20 and 40. The thickness (e) of the hollow tube 21 is less than \sqrt{D/3}. The chamfer 22 of the edge is produced from the outside of the tube to the inside of the tube so that the diameter of the cutting edge is equal to the inner diameter of the hollow tube.

In practice, the diameter of the holes to be produced, and consequently the inner diameter (D) of the hole punch can vary from 1 mm to 10 mm, even beyond that in the case of very large tires. The length of the channels varies from 20 mm to 400 mm and the maximum thickness (e) of the wall of the tube for which acceptable results have been obtained varies from 0.5 mm to 1.8 mm.

For reasons associated with its industrial life, a choice will preferably be made to produce the hole punch in a wear-resistant material, such as tungsten carbide.

FIG. 2 shows what happens when the rotary hole punch is used according to the claimed method.

It is observed that the action of the hole punch creates no waste to be evacuated because the material is cut by the cutting edge. By pressing into the material to be cut, the outer wall of the hole punch transversely compresses the material by subjecting it to a displacement equal to the thickness (e) of the wall of the hollow tube 20 as is shown by the arrows pointing towards the outer wall.

Also, the slimmer the thickness of the wall of the tube, the less great are the effects exerted on the wall of the tube and the less great are the frictions between the outer wall and the material. It has been shown that it is possible to obtain good results when said wall has a thickness (e) less than or equal to 1 mm, considering that, while there may be a desire to reduce this thickness, the limits imposed by the mechanical resistance of the hole punch are a limiting factor.

When the ratio of the speed of advance of the hole punch and the circumferential speed of the edge is within the limits claimed hereinabove, the cutting edge compresses the part of the material (a) that has not been cut and is located below said cutting edge. This has the effect of extending the part (b) of the material that has not yet been cut located immediately above the part (a). The result of this is a compression in the direction perpendicular to the axis of the hole punch of the part (b) of the material located inside the tube, which leads to a reduction in the diameter of the sprue just before the cut. Once the cut is made, the transverse stress is relaxed, and the sprue remains at a diameter (d) slightly less than the inner diameter (D) of the tube. It follows from this that the frictions between the sprue and the inner part of the hollow tube 20 are reduced and that, on the other hand, the extraction of the sprue C at the end of the cycle is greatly facilitated.

By increasing the ratio of the speeds beyond a value of 0.15, the compression of the material is increased which can prove favourable in one way given what has been described hereinabove, but there is then observed a very strong tendency to overheating of the tool and of the material to be bored which provokes a degradation of said material. When the value of the ratio falls below the experimental threshold of 0.03, the compression effect is then too small for it to be possible to obtain a sprue with a diameter that is sufficiently reduced for the effects described in the preceding paragraph to be significant.

As an example, good results are obtained for an inner diameter (d) of 6 mm and a rotation speed of the hole punch of 600 rpm, the advance is set to 2400 mm/min which gives a speed ratio of 0.1. For an inner diameter (d) of 2 mm and a rotation speed of 1400 rpm, the advance is 600 mm/min, which then gives a speed ratio of 0.034.

The limit values have been determined experimentally and are significant of the preferred operating range. It is nevertheless likely that a range of values wider than 0.02 to 0.2 can also give acceptable results, in particular when the elastic characteristics of the material to be bored vary.

At the end of the cutting cycle, the sprue has to be ejected before removing the hole punch from the freshly produced hole. Also, it is particularly advantageous to place a duct making it possible to feed a fluid under pressure inside the tube at the level of the inner end of the head.

Once the bore hole is made, and after the cutting part of the hole punch has passed through the block of rubber from one side to the other, said fluid is injected via the duct, and pressure is created inside the tube in the chamber between the sprue and the head of the hole punch, which has the effect of propelling the sprue through the open end of the tube located on the side where the cutting edge is located, and which discharges at this instant on the other side of the wall the thickness of material that has just been bored.

One the sprue has been ejected, it is then possible to remove the tool in total safety without running the risk of seeing the sprue retained in the orifice that has just been bored.

Furthermore, the ejection of the sprue is almost instantaneous which makes it possible to reduce the boring cycle time.

The hole punch according to the invention, represented in FIG. 3, comprises a cylindrical head 10 with circular section. The free end 11 can be gripped by a means able to drive it rotationally, such as, for example, the jaws of a drill or a machine tool mandrel, in which the hole punch can be held by clamping or by screw fastening. A duct 13 runs from the outside of the head of the hole punch and opens into the interior of the tube at the level of the bottom end 12 of the head 10.

The fluid under pressure is fed through the duct 13 using known means, such as a rotating o-ring seal, placed directly on the head of the hole punch at the level of the entry into the channel 13 or even by an intermediate part placed at the level of the driving jaws.

The fluid used can be liquid or gaseous. The injection of air under pressure presents the advantage of ease of use, and although the injection of water under pressure can prove more difficult, the use of this fluid presents the advantage of making it possible to lubricate the inner wall of the hole punch and evacuate the calories with a view to the next boring sequence.

Also, a particularly advantageous solution consists in injecting air containing micro-droplets of lubricating fluid in order to favour the sliding of the walls of the tool over the rubber. As an example, the lubricant can be water containing silicone in suspension.

It can also prove advantageous to continue the injection of the fluid throughout the duration of the extraction of the tool from the hole. This addition of extra fluid makes it possible to cool both the walls of the hole punch and the walls of the hole which prevents the creation of denaturation of the rubber materials linked to an excessive overheating.

When the overheating is particularly intense, it is recommended to also lubricate, conventionally, the outer wall of the hole punch before it penetrates into the core of the material to be bored.

By measuring the injection pressure of the fluid in the hole punch it is possible to detect the variation of pressure that occurs when the sprue is ejected from the tube. The abrupt reduction in pressure that follows makes it possible to determine that the ejection has taken place, and guarantee that the sprue has been extracted from the hole. This check, which is simple to perform, proves particularly useful in the context of production monitoring.

The various sequences of the boring method can be controlled using known means in which it is possible to programme the driving sequences of the drill spindle relative to the material to be bored.

The cutting edge 21 can have a straight-line form, located substantially in a plane perpendicular to the axis of rotation of the hole punch or, as is represented in the insets 3a and 3b, a sawtooth form or even a ripple form so as to enhance the quality and effectiveness of the cut.

A sawtooth form is particularly advantageous to favour the cutting of the material when the tool is brought towards the wall from the other end of the volume of material to be bored.

Finally, so as to avoid the tearing of the wall at the end of the boring, it is recommended to reduce the speed of advance of the hole punch.

FIGS. 4 and 5 show a tire P in which holes B have been bored roughly axially in the sculptural elements of the tire tread level with the shoulder zone.

It is also perfectly possible to consider boring the sculptural elements over the entire width of the tire tread by providing a hole punch of appropriate length. In this configuration, the sprues are ejected each time a circumferential furrow is crossed so as to ensure, as explained hereinabove, that all the sculptural elements have indeed been bored from one side to the other.

To produce a large quantity of holes, it is particularly advantageous to have a plurality of hole punches according to the invention operate simultaneously.

These hole punches are positioned on a common chassis and are arranged so that the axes of rotation are substantially oriented in the axial direction, and the cutting edges are positioned on a circle located in a plane perpendicular to the axes of rotation.

However, the axes of the hole punch can have a slight angular deviation from the axial direction of the tire, to take account of the transversal curvature of the sculpture.

The radius of the circle is adapted to the dimensions of the tire and to the boring radius and can be adjustable if necessary, involving adapting the driving mechanics and automatic functions.

The tool comprising the hole punches is presented axially facing the shoulders of the tire and the holes are produced in a single pass according to the procedure described hereinabove.

The number of hole punches positioned in this way corresponds in theory to the number of holes B to be produced. If, however, the number of holes to be produced is large or if the bulk of the hole punches does not make it possible to have a number of hole punches corresponding to the number of holes, it is possible to use a number of hole punches corresponding to a whole fraction of the number of holes to be produced.

In these conditions, the boring of the set of holes is done in several passes, by subjecting the tire, between each pass, to a relative axial rotation relative to the boring device, by the value corresponding to the angular difference between two consecutive holes.

1. A rotary hole punch (T) comprising a cylindrical head (10) of circular section, the free end (11) of which is able to be gripped by a means intended to drive said hole punch rotationally, and a cylindrical tube (20) of circular section, attached to the bottom end (12) of the head (10), of which the ratio between the length (L) and the diameter (D) is between 20 and 40, characterized in that wherein:
the tube ends in a cutting edge (21) formed by a chamfering (22) of the outer wall of the cylindrical tube (20), and
said wall has a thickness (e) less than or equal to \sqrt{D/3}, where D represents the inner diameter of the cylindrical tube (20).

2. The hole punch according to claim 1, wherein the head (10) of the hole punch includes a duct (13) for feeding a fluid under pressure inside the tube (10) at the level of the inner end (12) of the head (10).

3. The hole punch according to claim 1, wherein the cutting edge (21a) has a sawtooth form.

4. A boring device comprising a plurality of hole punches (T) according to claim 1, arranged so that the rotation axes are substantially parallel to each other and the cutting edges are positioned on a circle located in a plane, perpendicular to the rotation axes.

5. A method of boring bit by bit to a given thickness material made of rubber, in which a rotary hole punch (T) according to claim 1 is used, wherein the ratio between the speed of advance of the hole punch in the axial direction and the circumferential speed at the level of the cutting edge is between 0.02 and 0.2.

6. The boring method according to claim 5, wherein the ratio between the speed of advance of the hole punch in the axial direction and the circumferential speed at the level of the cutting edge is between 0.03 and 0.15.

7. The boring method according to claim 5 wherein the sprue (C) contained in the tube (20) of the hole punch (T) is ejected by feeding a fluid under pressure into the chamber located inside the tube between the inner end (12) of the head (10) and the sprue (C).

8. The boring method according to claim 7, wherein the fluid under pressure is fed immediately after the cutting part (21, 21a, 21b) has broken through the other side of the thickness of the product to be bored.

9. The boring method according to claim 7, wherein the hole punch is removed from the hole after having ejected the sprue.

10. The boring method according to claim 9, wherein the injection of the fluid is continued while the hole punch is being removed from the hole.

11. The boring method according to claim 7, wherein the injected fluid is air under pressure.

12. The boring method according to claim 7, wherein the injected fluid is water under pressure.

13. The boding method according to claim 7 wherein the injected fluid is air mixed with micro-droplets of a lubricating fluid.

14. The boding method according to claim 13, wherein the lubricating fluid is water mixed with silicone in suspension.

15. (canceled)
